(19) United States
(12) Patent Application Publication
(10) Pub. No.: US 2017/0210538 A1
(43) Pub. Date: Jul. 27, 2017

(54) SAFE AND STABILIZED STORAGE EQUIPMENT FOR GEOCHEMISTRY RESEARCH

(71) Applicant: China University of Petroleum (East China), QINGDAO (CN)

(72) Inventors: YING SONG, QINGDAO (CN); YING QI, QINGDAO (CN); CHENGLIN CONG, TAMPA, FL (US); JUNXIA ZHANG, WUHAN (CN)

(73) Assignee: China University of Petroleum (East China)

(21) Appl. No.: 15/482,814

(22) Filed: Apr. 9, 2017

Related U.S. Application Data
(63) Continuation of application No. PCT/CN2016/077553, filed on Mar. 28, 2016.

(30) Foreign Application Priority Data
Apr. 30, 2015 (CN) 201510216082.8

(51) Int. Cl. B65D 81/05; B65D 55/14; B65D 25/02; A62D 3/30; B65D 85/00; B65D 25/14; B65D 53/02; B65D 43/02; B65D 81/38; B65D 25/20

(52) U.S. Cl. CPC B65D 81/05; B65D 81/38; B65D 55/14; B65D 25/02; B65D 25/20; B65D 85/70; B65D 25/14; B65D 53/02; B65D 43/0225; A62D 3/30; B65D 2581/02

(57) ABSTRACT

The invention is a safe and stabilized storage equipment for geochemistry research belonging to the chemical storage field. The container comprises an cuter sleeve, a main body of the liquid storage, a stabilizer storage mechanism, a main body pedestal, an Main body inner lid mechanism and a Neutralizer storage release mechanism. It is mostly used for storing high-precision chemicals: maintain the chemical properties of the chemicals during storage and transport, and automatically and quickly neutralize them in case of emergency to avoid chemical leakage and environment pollution. The storage process is safe and reliable, which has benefited the storage and transport of industrial hazardous chemicals, laboratory reagents, petrochemical and coal chemical products to a certain extent.

### CROSS-REFERENCE TO RELATED APPLICATIONS

This application is a continuation of International Patent Application No. PCT/CN2016/077553 with a filing date of Mar. 28, 2016, designating the United States, now pending, and further claims priority to Chinese Patent Application No. 201510216082.8 with a filing date of Apr. 30 2015. The content of the aforementioned application, including any intervening amendments thereto, are incorporated herein by reference.

### TECHNICAL FIELD

The invention belongs to the chemical storage field. It is a safe and stabilized storage equipment for geochemistry research.

### BACKGROUND OF THE PRESENT INVENTION

Chemicals are widely used in daily production and research activities. Some chemicals are hazardous during the usage, storage and transport processes. Frequent and unavoidable accidental deteriorate leakage, disclosure, loss and other accidents not only pollute the natural environment, but also affect people's everyday life. Therefore, the appropriate storage containers for chemicals can effectively prevent metamorphism and leakage of chemicals during storage and transport, and can greatly reduce accidents like disclosure, combustion, explosion, corrosion, poisoning, etc.

Existed chemical storage containers usually are made of glass, plastic and metal. However, the traditional storage containers are not bulletproof, stab resistant, shockproof and anti-disclosure. Stabilizers cannot be added to the chemicals according to their properties to maintain stability. In addition, the chemicals cannot be automatically neutralized in emergency with the aim of reducing environment pollution.

### SUMMARY OF PRESENT INVENTION

A safe and stabilized storage equipment for geochemistry research is invented to overcome the shortages of the current chemical storage containers. The multilayered container is made of special material with corrosion resistant bulletproof, shockproof, stab resistant and anti-theft functions. There is a specific stabilizer repository which can automatically neutralize chemicals in emergency to avoid environment pollution.

The invention is designed to solve the above problems, and the technical schemes are as follows:

The safe and stabilized storage equipment for geochemistry research comprises an outer sleeve, a main body of the liquid storage, a stabilizer storage mechanism, a main body pedestal a main body inner lid mechanism and a neutralizer storage release mechanism:

The outer sleeve is consisted of an outer lining, rubber brackets, Absorb vibration leaf springs, Absorb vibration springs and an inner lining. The outer sleeve is wrapped up by the outer lining with zippers on it. Between the outer and inner linings the rubber brackets are installed in the middle of the sleeve, with several slots in the circumferential direction and several bases at the bottom. The Absorb vibration leaf springs are evenly distributed in the slots, while the Absorb vibration springs are in the base.

The main body of the liquid storage includes an inner tank, a soft hose, a shell, an mounting pedestal auxiliary mount for thermal insulation filler, thermal insulation fillers a Absorb vibration spring, an outer lid, a plastic ring, a mechanical lock and a keyhole. The soft hose, which is made from material that is bulletproof, stab-resistant and shockproof enwraps the shell. The shell enwrapping the inner tank is made of high strength special shell. Made from corrosion resistant material, the inner tank contains two layers. The gap between the two layers is filled with a thermal insulation filler mounting pedestal. The auxiliary mount mounting pedestal for thermal insulation filler is made of soft rubber and installed at the bottom of the tank with threads. The Absorb vibration spring locates between the tank bottom and the mounting pedestal. Securely connected to the outside of the tank, the plastic mounting ring locates on the outer edge of the top of soft hose and shell. There is a pin shaft hole on the upper part of the ring, connecting the outer lid with the pin shaft. The mechanical lock is installed around the ring, while the keyhole is in the circumferential direction of the ring, under the lock. The outer lid is fitted on the plastic mounting ring by the pin with a pin shaft hole and a retaining ring of mechanical lock on each, side.

The stabilizer storage mechanism contains a stabilizer holder, a stabilizer box, a stabilizer locking ring and a fixed plate of stabilizer holder. The stabilizer holder is fixed in the mounting slot inside the inner tank bottom, with flow hole, mounting slot of stabilizer box and fixed plate and mounting hole of locking ring on the upper and lower surfaces. There are flow holes on the surrounding surfaces and at the bottom of the stabilizer box which is installed in the mounting slot of the holder by overhang flanges. The locking ring is fixed in the mounting holes in the middle of the holder and the fixed plate. The fixed plate is installed in the mounting slot with its overhang cylinders fixed in the holder chute from both sides and the locking ring connected to the holder in the middle.

The main body pedestal consists of a mounting pedestal, a drawer slide and box. The mounting pedestal is installed at the bottom of the tank with screw threads. Between the auxiliary mount mounting pedestal for insulation filler and the mounting pedestal is the Absorb vibration spring. The drawer box is fitted in the mounting slot in the middle of the mounting pedestal, while the drawer slide is in the chute around the mounting pedestal and the drawer box.

The inner lid of the main body is made up of a safety pin of the inner lid, a movable inner lid, a fixed inner lid, a gasket and a seal ring. The fixed inner lid is installed inside the upper part of the inner tank by screw threads with three extraction solution holes and a safety locking hole on the top. The angular spacing s between extraction solution holes are 60, 120 and 180 degrees respectively. The movable inner lid fits inside the fixed one with three extraction solution holes on the top. The angular spacing between adjacent mouths are 60, 120 and 180 degrees respectively. There is a mounting slot in the circumferential direction and a hollow mounting boss with tapered surface inside in the middle of the movable lid. The safety pin is installed in the locking hole of the fixed inner lid and pressed against the upper surface of the gasket. The gasket is made of high-elastic corrosion-resistant material and the upper part is provided with three extraction solution holes corresponding to the holes on the movable inner lid. On the upper surface of the movable inner lid, it locates between the fixed and the movable lids. The seal ring fits in the mounting slot in the circumferential direction of the movable lid.

The neutralizer storage release mechanism is composed of a rubber mounting pedestal, a return spring, a rubber block, a tablet, a neutralizer release spring, a neutralizer release lid and neutralizer release push rods. The rubber mount is threadedly connected to the inner lower part of the boss in the middle part of the movable inner cap, and a through hole is formed in the middle part. The upper part thereof is provided with a tapered surface mounting pedestal The rubber block are molded by rubber casting and fits inside the mounting boss in the middle of the movable lid with outer inward tapered side outside, inner outward and inward tapered side inside and space for neutralizer storage in the middle. The mounting, slot for push rod is evenly distributed in the circumferential direction under the block. It is the same with four gaps which divide the lower part into four sections. The outer inward tapered side contacts with the inner tapered surface in the middle of the movable inner lid, while the inner inward tapered side contacts with the outer tapered surface of the rubber mounting pedestal. The return spring is placed between the upper surface of the rubber mounting pedestal and the lower surface of the rubber block. The tablet sets between the movable inner lid and the top of the rubber block, with mounting slot and elastic seal ring in the circumferential direction. Made from elastic material, the neutralizer release lid is fitted in the space where the neutralizer is stored in the middle of the rubber block. On the upper part of it evenly distribute four overhang flanges which are installed on the top of the push rod mounting slot of the rubber block. Inside the release lid, the neutralizer release spring is between it and the rubber block. The neutralizer release push rods are fixed in the push rod mounting slot of the rubber block; its upper surface and lower surface contact the tapered surface of neutralizer release lid's overhang flange and the bottom of the rubber mounting pedestal's tapered surface.

Advantages of the invention: it is mostly used for storing high-precision chemicals: maintain the chemical properties of the chemicals during storage and transport, and automatically and quickly neutralize them in case of emergency to avoid chemical leakage and environment pollution. The storage process is safe and reliable, which has benefited the storage and transport of industrial hazardous chemicals to a certain extent.

### DESCRIPTION OF THE DRAWINGS

FIG. 1 is a schematic diagram of the present invention—a safe and stabilized storage equipment for geochemistry research.

FIG. 2 is a schematic diagram of the outer sleeve to the present invention.

FIG. 3 is a schematic diagram of the central part of the main body of the liquid storage to the present invention,

FIG. 4 is a schematic diagram of the central and lower part of the main body of the liquid storage to the present invention.

FIG. 5 is a schematic diagram of the back upper and central part of the main body of the liquid storage to the present invention.

FIG. 6 is a schematic diagram of the front upper and central part of the main body of the liquid storage to the present invention.

FIG. 7 is a schematic diagram of the stabilizer storage mechanism to the present invention.

FIG. 8 is a schematic diagram of the inner lid of the main body to the present invention.

FIG. 9 is a schematic diagram of the neutralizer storage release mechanism to the present invention.

FIG. 10 is a broken out section view—schematic diagram of he neutralizer storage release mechanism to the present invention.

FIG. 11 is an interior schematic diagram of the neutralizer storage release mechanism to the present invention.

FIG. 12 is a working principle diagram of the neutralizer storage release mechanism to the present invention.

FIG. 13 is a connection schematic diagram of the rubber block and the neutralizer release lid of the neutralizer storage release mechanism to the present invention.

FIG. 14 is a connection schematic diagram of the rubber mounting pedestal and the neutralizer release lid of the neutralizer storage release mechanism to the present invention.

FIG. 15 is a connection schematic diagram of the rubber mounting pedestal and the rubber block of the neutralizer storage release mechanism to the present invention.

FIG. 16 is a schematic diagram of the rubber block of he neutralizer storage release mechanism to the present invention.

order number

1. outer sleeve, 2 main body of the liquid storage 3. stabilizer storage mechanism, 4. body pedestal, 5. Main body inner lid mechanism, 6. neutralizer storage release mechanism;

1.1. outer lining, 1.2. rubber bracket, 1.3. Absorb vibration leaf spring, 1.4. Absorb vibration spring, 1.5. inner lining, 2.1. tank, 2.2. soft hose, 2.3.shell, 2.4. supplementary mounting pedestal for thermal insulation filler, 2.5. thermal insulation filler, 2.6. Absorb vibration spring, 2.7. outer lid, 2.8. plastic mounting ring. 2.9. mechanical lock, 2.10. keyhole of the mechanical lock, 3.1. stabilizer holder, 3.2, stabilizer box, 3.3. stabilizer locking ring 3.4. retainer plate of stabilizer holder, 4.1. mounting pedestal, 4.2. drawer slide, 4.3. drawer box, 5.1. safety pin of the inner lid, 5.2, movable inner lid, 5.3 fixed inner lid, 5.4, gasket, 5.5. seal ring, 6.1 rubber mounting pedestal, 6.2. return spring, 6.3. rubber block, 6.4. tablet, 6.5 neutralizer release spring, 6.6. neutralizer release lid* 6.7. neutralizer release push rod;

1.1.1. outer sleeve zipper, 2.7.1. pinhole of outer lid, 2.9.1. retaining ring of mechanical lock, 6.3.1. mounting slot of push rod, 6.3.2. inner outward side, 6.3.3. inner inclined surface, 6.3.4. outer inclined surface, 6.6.1. overhang mounting flange.

### DETAILED DESCRIPTION OF PREFERRED EMBODIMENTS

specific example combined with the drawings:

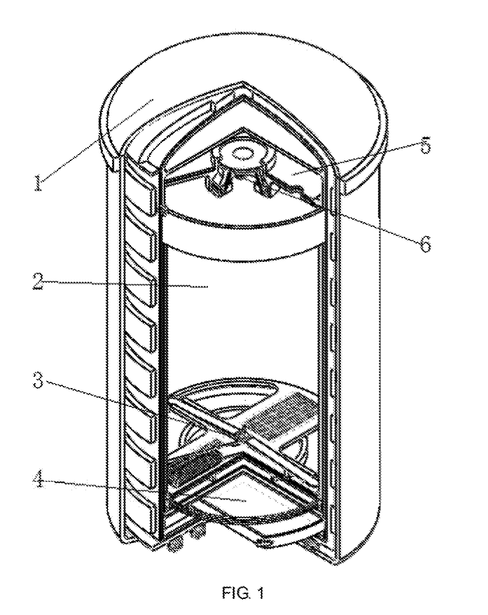

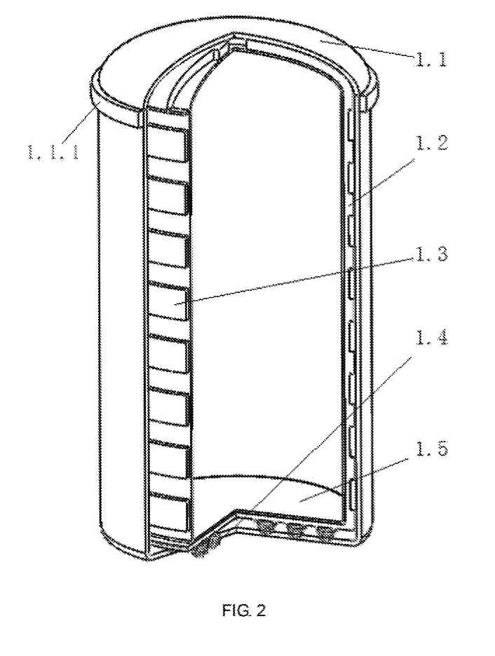

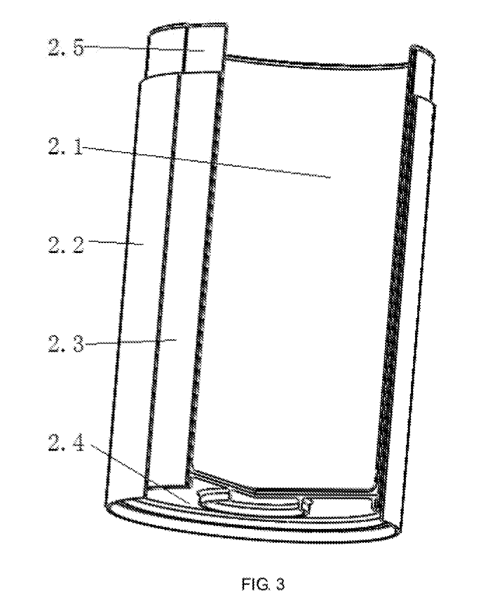

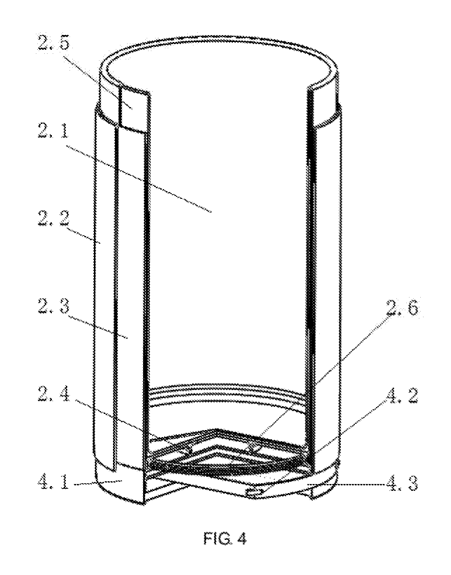

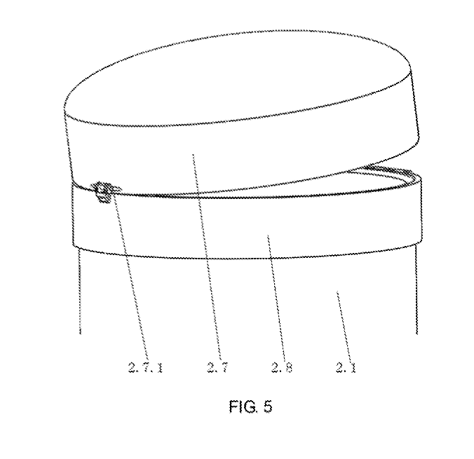

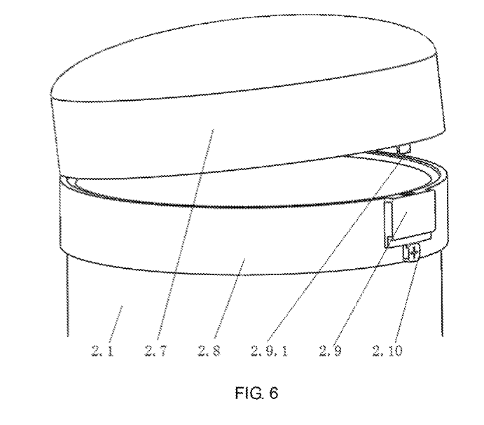

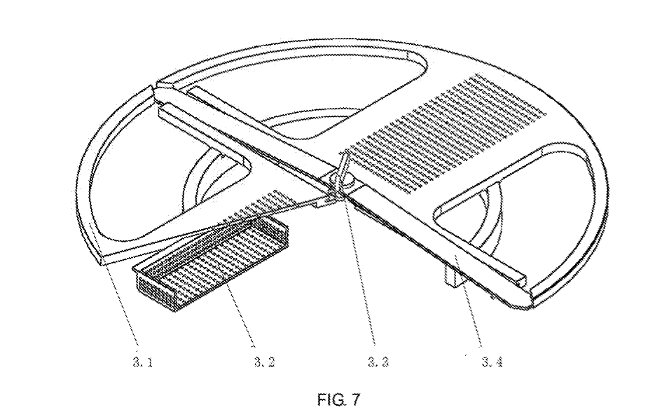

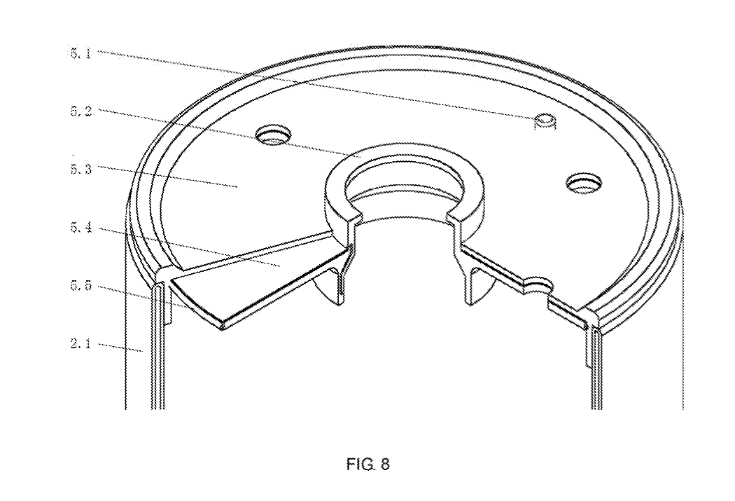

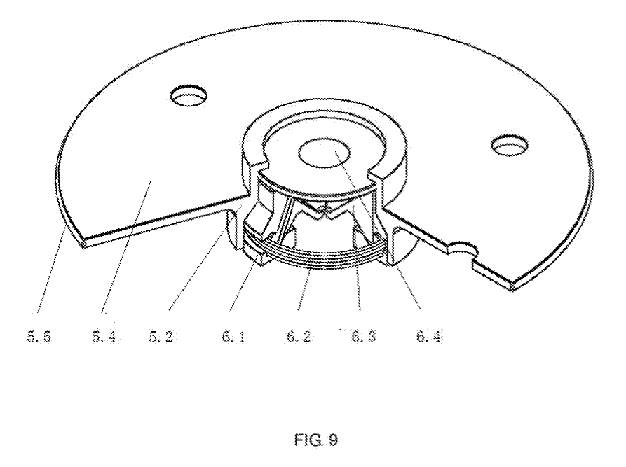

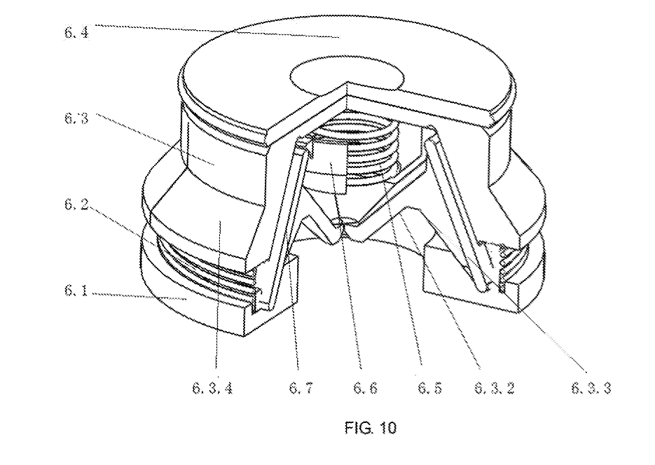

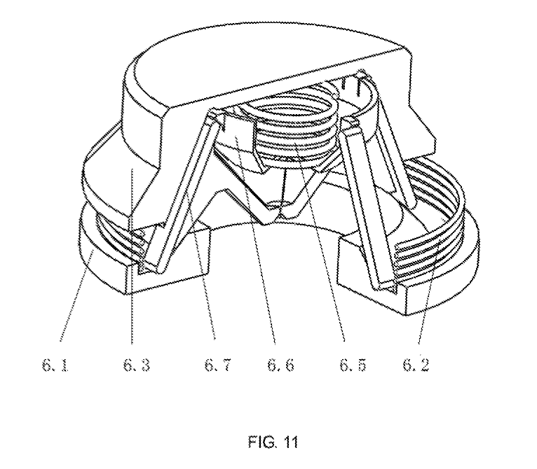

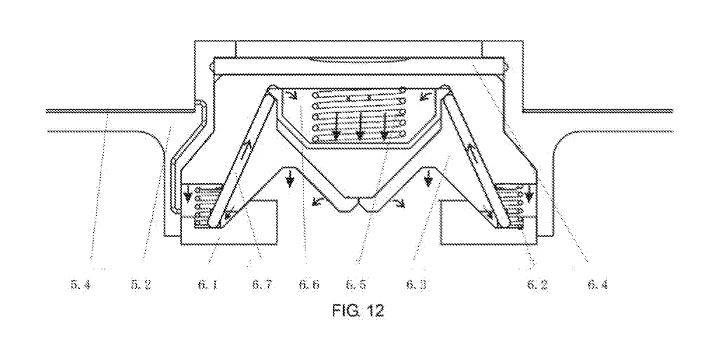

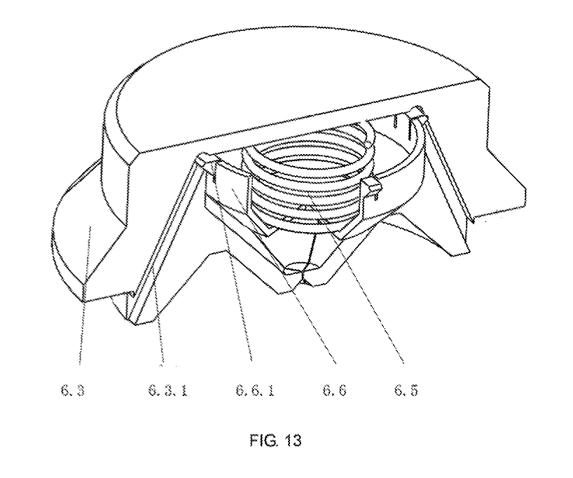

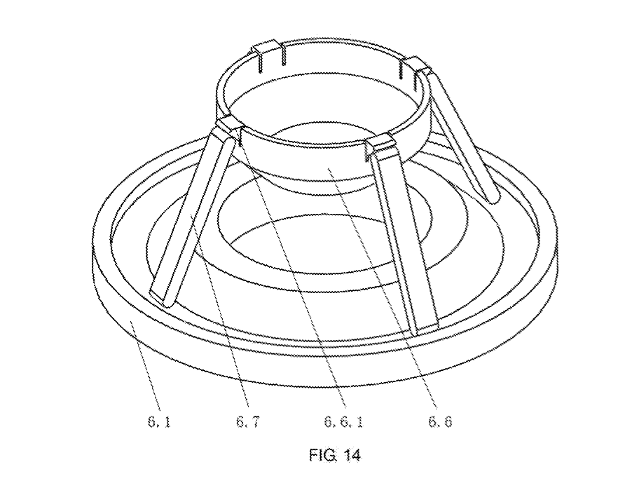

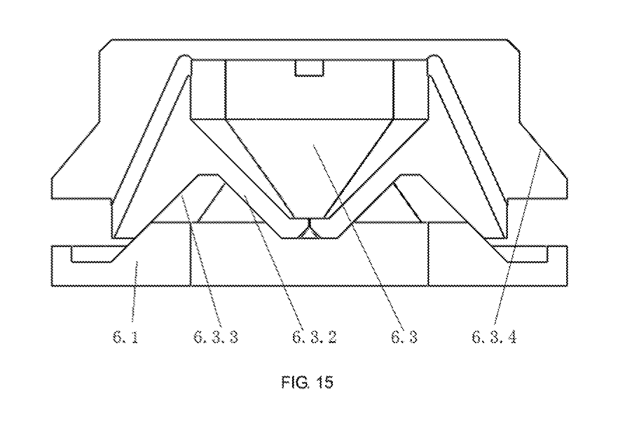

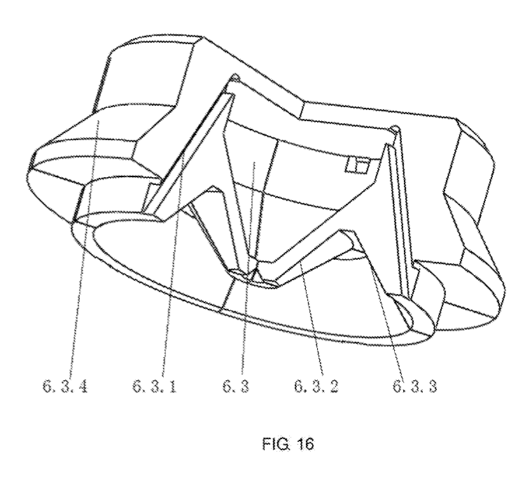

As shown in FIG. 1-16, a safe and stabilized storage equipment for geochemistry research is made up of outer sleeve 1, main body of the liquid storage 2, stabilizer storage mechanism 3, main body pedestal 4, Main body inner lid mechanism 5 and neutralizer storage release mechanism 6 including outer lining 1.1, rubber bracket 1.2, Absorb vibration leaf spring 1.3. Absorb vibration spring 1.4, inner lining 1.5, tank 2,1, soft hose 2.2, shell 2.3, supplementary mounting pedestal for thermal insulation filler 2.4, thermal insulation filler 2.5, Absorb vibration spring 2.6, outer lid 2.7, plastic mounting ring 2.8, mechanical lock 2.9, keyhole of the mechanical lock 2.10, stabilizer holder 3.1, stabilizer box 3.2, stabilizer locking hook 3.3, retainer plate of stabilizer holder 3.4, mounting pedestal 4.1, drawer slide 4.2, drawer box 4.3, safety pin of the inner lid 5.1, movable inner lid 5.2, fixed inner lid 5.3, gasket 6.4, seal ring 5.5, rubber mounting pedestal 6.1, return spring 6.2, rubber block 6.3, tablet 6.4, neutralizer release spring 6.5, neutralizer release lid 6.6, neutralizer release push rod 6.7, outer sleeve zipper 1.1.1, pinhole of outer lid 2.7.1, retaining ring of mechanical lock 2.9.1, push rod mounting slot 6.3.1, inner outward side 6.3.2, inner inclined surface 6.3.3, outer inclined surface 6.3.4, and overhang mounting flange 6.6.1.

Outer sleeve 1 is consisted of outer lining 1.1, rubber bracket 1.2, Absorb vibration leaf spring 1.3, Absorb vibration spring 1.4 and inner lining 1.5. The outer sleeve 1 is wrapped up by the outer lining 1.1 with outer sleeve zipper 1.1.1 on it. Between outer lining 1.1 and inner lining 1.5, rubber bracket 1.2 is installed in the middle of the sleeve, with several slots in the circumferential direction and several bases at the bottom. Absorb vibration leaf springs 1.3 are distributed in the slots, while the Absorb vibration springs 1.4 are in the base of rubber bracket 1.2.

Solutions stored in the main body can be put into inner lining 1.5. The outer lining 1.1 is sealed by outer sleeve zipper 1.1.1 to protect the main body of the liquid storage 2 and reduce vibration influence to it.

Main body of the liquid storage 2 includes tank 2.1, soft hose 2.2, shell 2.3, supplementary mounting pedestal for thermal insulation filler 2.4, thermal insulation filler 2.5, Absorb vibration spring 2.6, outer lid 2.7, plastic mounting ring 2.8, mechanical lock 2.9 and keyhole of the mechanical lock 2.10. Soft hose 2.2, which is made from material that is bulletproof, stab-resistant and shockproof enwraps shell 2.3. Shell 2.3 enwrapping tank 2.1 is made of high strength special steel. Made from corrosion resistant material, tank 2.1 contains two layers. The thermal insulation fillers 2.5 are filled in the gaps between tank 2.1 layers and between tank 2.1 bottom and auxiliary mount, mounting pedestal for insulation filler 2.4. Auxiliary mount mounting pedestal for insulation filler 2.4 is made of soft rubber and installed at the bottom of tank 2.1 with threads. Absorb vibration spring 2.6 locates between tank 2.1 bottom and mounting pedestal 4.1. Securely connected to the outside of tank 2.1, plastic mounting ring 2.8 locates on the outer edge of the top of soft hose 2.2 and shell 2.3. There is a pinhole on the upper part of the ring, connecting the outer lid 2.7 with the pin. Mechanical lock 2.9 is installed around the ring, while keyhole of the mechanical lock 2.10 is in the circumferential direction of plastic mounting ring 2.8 under the lock 2.9. Outer lid 2.7 is fitted on plastic mounting ring 2.8 by the pin with pinhole of outer lid 2.7.1 and retaining ring of mechanical lock 2.9.1 on each side.

Tank 2.1 will not be corroded by solutions because of the corrosion resistant material when solutions are stored in tank 2.1. Insulation filler 2.5 can provide a suitable storing environment with proper temperature for the solution. Shell 2.3 made from high strength special steel can protect the tank. Soft hose 2.2, the outermost layer, is bulletproof, stab-resistant and shockproof. External axial impacts on tank 2.1 can be reduced by Absorb vibration spring 2.6. If unlocking needed, mechanical lock 2.9 can be opened through keyhole of the mechanical lock 2.10.

Stabilizer storage mechanism 3 contains stabilizer holder 3.1, stabilizer box 3.2, stabilizer locking ring 3.3 and retainer plate of stabilizer holder 3.4. Stabilizer holder 3.1 is fixed in the mounting slot inside the bottom of inner tank 2.1, with flow hole, mounting slot of stabilizer box and fixed plate and mounting hole of locking ring on the upper and lower surfaces. There are flow holes on the surrounding surfaces and at the, bottom of stabilizer box 3.2 which is installed in the mounting slot of stabilizer holder 3.1 by overhang flanges. Stabilizer locking ring 3.3 is fixed in the mounting holes in the middle of stabilizer holder 3.1 and retainer plate of stabilizer holder 3.4. Fixed plate of stabilizer holder 3.4 is installed in the mounting slot of stabilizer holder 3.1 with its overhang cylinders of fixed plate of stabilizer holder 3.4 fixed in the holder chute of stabilizer holder 3.1 from both sides and stabilizer locking ring 3.3 connected to stabilizer holder 3.1 in the middle.

Put solid stabilizer into stabilizer box 3.2, and then installed onto stabilizer holder 3.1 with a hook connected to stabilizer locking ring 3.3. Place stabilizer holder 3.1 in the mounting pedestal at the bottom of inner tank 2.1. Press stabilizer locking ring 3.3 to put the edge of stabilizer holder 3.1 into the mounting pedestal at the bottom of inner tank 2.1 driven by fixed plate of stabilizer holder 3.4 so stabilizer holder 3.1 is fixed in tank 2.1. Rotate the stabilizer locking ring 3.3 to fix the retainer plate of stabilizer holder 3,4 onto the stabilizer holder 3.1 so that the stabilizer holder 3.1 is fixed in the tank 2.1. Solutions can contact with the solid stabilizer through the flow holes on stabilizer holder 3.1 and stabilizer box 3.2 after storage, so the chemical stability of the solution is ensured during transport.

Main body pedestal 4 consists of mounting pedestal 4.1, drawer slide 4.2 and box 4.3. Mounting pedestal 4.1 is installed at the bottom of tank 2.1 with threads. Between auxiliary mount mounting pedestal for insulation filler 2.4 and pedestal mounting pedestal 4.1 is Absorb vibration spring 2.6. Drawer box 4.3 is fitted in the mounting slot in the middle of mounting pedestal 4.1, while drawer slide 4.2 is in the chute around mounting pedestal 4.1 and drawer box 4.3.

Stuffs like chemicals can be stored in drawer box 4.3. Drawer box 4.3 can be pulled out or locked with drawer slide 4.2.

Inner lid of the main body 6 is made up of safety pin of the inner lid 5.1, movable inner lid 5.2, fixed inner lid 5.3, gasket 5.4 and seal ring 5.5. Fixed inner lid 5.3 is installed inside the upper part of inner tank 2.1 by screw threads with three extraction solution holes and a locking hole on the top. The angular spacing a between adjacent mouths are 60, 120 and 180 degrees respectively. Movable inner lid 5.2 fits inside fixed inner lid 5.3 with three extraction solution holes on the top. The angular spacing between adjacent mouths are 60, 120 and 180 degrees respectively. There is a mounting slot in the circumferential direction and a hollow mounting boss with tapered surface inside in the middle of the movable lid. Safety pin of the inner lid 5.1 is installed in the locking hole of fixed inner lid 5.3 arid pressed against to the upper surface of gasket 5.4. Gasket 5.4 is made of high-elastic corrosion-resistant material with three extraction solution holes matching the holes on movable inner lid 5.2. On the upper surface of movable inner lid 5.2, it locates between movable inner lid 5.2 and movable inner lid 5.2. Seal ring 5.5 fits in the mounting slot in the circumferential direction of movable inner lid 5.2.

When collecting the liquid, first get off safety pin of the inner lid 5.1, and then turn the cylindrical boss on, movable inner lid 5.2 to make the liquid collecting mouths on movable inner lid 5.2 and fixed inner lid 5.3 meet so that one, two or three extraction solution holes is/are open for different needs. Without liquid collecting, turn the cylindrical boss on movable inner lid 5.2 to make the liquid collecting mouths on movable inner lid 5.2 and fixed inner lid 5.3 in different positions. Fix safety pin of the inner lid 5.1 into the locking hole of fixed inner lid 5.3, and press gasket 5.4 and movable inner lid 6.2. Fix the relative positions of movable inner lid 5.2 and fixed inner lid 5.3 to avoid movement.

Neutralizer storage release mechanism 6 is composed of rubber mounting pedestal 6.1, return spring 6.2, rubber block 6.3. tablet 6.4, neutralizer release spring 6.5, neutralizer release lid 6.6 and neutralizer release push rod 6.7. The rubber mounting pedestal 6.1 is threadedly connected to the inner lower part of the boss in the middle part of the movable inner lid 5.2 with a through hole forming in its middle part and a conical surface upside. Rubber block 6.3 are molded by rubber casting and fits inside the mounting boss in the middle of movable inner lid 5.2 with outer inclined surface 6.3.4 outside, inner outward side 6.3.2 and inner inclined surface 6.3.3 inside and space for neutralizer storage in the middle. Push rod mounting slot 6.3.1 is evenly distributed in the circumferential direction under the block. It is the same with four gaps which divide the lower part into four sections. Outer inclined surface 6.3.4 contacts the inner tapered surface in the middle of movable inner lid 5.2, while inner inclined surface 6.3.3 contacts the outer tapered surface of rubber mounting pedestal 6.1. Return spring 62 is placed between the upper surface of rubber mounting pedestal 6.1 and the lower surface of rubber block 6.3. Tablet 6.4 sets between movable inner lid 5.2 and the top of rubber block 6.3, with mounting slot and elastic seal ring in the circumferential direction. Made from elastic material, neutralizer release lid 6.6 is fitted in the space where, the neutralizer is stored in the middle of rubber block 6.3. On the upper part of it evenly distribute four overhang mounting flanges 6.6.1 which are installed on the top of push rod mounting slot 6.3.1 of rubber block 6.3.Insicle neutralizer release lid 6.6, neutralizer release spring 6.5 is between neutralizer release lid 6.6 and rubber block 6.3. Neutralizer release push rods 6.7 are fixed in push rod mounting slot 6.3.1 of rubber block 6.3; its upper surface and lower surface contact the tapered surface of neutralizer release lid 6.6's overhang mounting flange 6.6.1 and the bottom of rubber mounting pedestal 6.1's tapered surface.

In the assembling of neutralizer storage release mechanism 6, enlarge the four sections of rubber block 6.3 with tools to make neutralizer release spring 6.5 and neutralizer release lid 6.6 entering into the storage space in the middle of rubber block 6.3. Then, put neutralizer release push rods 6.7 into push rod mounting slot 6.3.1 of rubber block 6.3. Set rubber block 6.3, tablet 6.4, neutralizer release spring 6.5, neutralizer release lid 6.6 and neutralizer release push rod 6.7 on the hollow mounting boss in the middle of movable inner lid 5.2. Lay rubber mounting pedestal 6.1 and return spring 6.2 under rubber black 6.3 with rubber mounting pedestal 6.1 and return spring 6.2 pressing rubber block 6.3 and tablet 6.4 axially. After assembling of neutralizer storage release mechanism 6 and before storing solutions in tank 2.1, open inner outward side 6.3.2 at the bottom of rubber block 6.3 with rod, move neutralizer release lid 6.6 upward, and press neutralizer release spring 6.5 until overhang mounting flange 6.6.1 of neutralizer release lid 6.6 fixed into the top of push rod mounting slot of rubber block 6.3. Open inner outward side 6.3.2 at the bottom of rubber block 6.3 with the funnel and pour the granular neutralizer into the central part of rubber block 6.3 working as the neutralizer storage space. Removing the funnel, outer inclined surface 6.3.4 of rubber block 6.3 and the inner tapered surface of movable inner lid 5.2 are compacted because of the elasticity of return spring 6.2, making rubber block 6.3 contracted. When rubber block 6.3 moves upward, its inner inclined surface 6.3.3 moves relatively against the tapered surface of a rubber mounting pedestal 6.1. The four sub-blocks of rubber block 6.3 contract inward, making the gaps between the sub-blocks closed so that the, neutralizer is sealed in the storage space. In case of emergency, press tablet 6.4 with hand to move rubber block 6.3 downward and compress return spring 6.2. Inner inclined surface 6.3.3 of rubber block 6.3 and the outer tapered surface of rubber mounting pedestal 6.1 are compressed. Outer inclined surface 6.3.4 of rubber block 6.3 and the inner tapered surface in the middle of movable inner lid 5.2 move against each other relatively, making rubber block 6.3 relax. The four sub-blocks of rubber block 6.3 expand, making the gaps between the four sub-blocks of rubber block 6.3 enlarged. Meanwhile, four neutralizer release push rods 6.7 push four overhang mounting flanges 6.6.1 on the edge of neutralizer release lid 6.6. Neutralizer release lid 6.6 pops out and moves down to the neutralizer storage space within rubber block 6.3 under the function of neutralizer release spring 6.5. Therefore, the neutralizer enters into tank 2.1 through the, gaps in rubber block 6.3 and mixed with the solutions in tank 2.1 to inactivate the solution.

W claim:

1. A safe and stabilized storage equipment for geochemistry research, comprising an outer sleeve, a main body of the liquid storage, a stabilizer storage mechanism, a main body pedestal, a main body inner lid mechanism and a neutralizer storage release mechanism:
wherein the outer sleeve comprises an outer lining, rubber brackets, shock absorbing spring plates, shock absorbing springs and an inner lining, wherein the outer sleeve is wrapped up by the outer lining with zippers on it, wherein between the outer and inner linings, the rubber brackets are installed in the middle of the sleeve, with several slots in the circumferential direction and several pedestal at the bottom, and wherein the shock absorbing spring plates are evenly distributed in the slots, while the shock absorbing springs are in the pedestal;
wherein the main body of the liquid storage comprises an inner tank, a soft hose, a shell, an auxiliary mount mounting pedestal for thermal insulation filler, thermal insulation fillers, ashock absorbing spring, an outer lid, a plastic ring, a mechanical lock and, a keyhole, wherein the soft hose, which is made from material that is bulletproof, stab-resistant and shockproof enwraps the shell, wherein the shell enwrapping the inner tank is made of high strength special steel, wherein the inner tank is made of a corrosion resistant material and comprises two layers, wherein gap between the two layers is filled with a thermal insulation filler mounting pedestal, wherein the auxiliary mounting pedestal for the thermal insulation filler is made of soft rubber and installed at the bottom of the tank with threads, wherein the shock absorbing spring is located between the bottom of the inner tank and the mounting pedestal, wherein the plastic mounting ring is securely connected to the outside of the tank and located on the outer edge at the top of soft hose and shell, wherein there is a pin shaft hole on the upper part of the ring, connecting the outer lid with the pin shaft, wherein the mechanical lock is installed around the ring, while the keyhole is in the circumferential direction of the ring, under the lock, and wherein the outer lid is fitted on the plastic mounting ring by the pin with a pin shaft hole and a retaining ring of mechanical lock on each side;
wherein the stabilizer storage mechanism contains a stabilizer holder, a stabilizer box, a stabilizer locking ring and a fixed plate of stabilizer holder, wherein the stabilizer holder is fixed in the mounting slot inside the inner tank bottom, with Flow hole, mounting slot of stabilizer box and fixed plate and mounting hole of locking ring on the upper and lower surfaces, wherein there are flow holes on the surrounding surfaces and at, the bottom of the stabilizer box which is installed in the mounting slot of the holder by overhang flanges, wherein there locking ring is fixed in the mounting holes in the middle of the holder and the fixed plate, and wherein the fixed plate is installed in the mounting slot with its overhang cylinders fixed in the holder chute from both sides and the locking ring connected to the holder in the middle;
wherein the main body pedestal comprises a mounting pedestal, a drawer slide and box, wherein the mounting pedestal is installed at the bottom of the tank with screw threads, wherein between the auxiliary mount mounting pedestal for insulation filler and the mounting pedestal is the shock absorbing spring, and wherein the drawer box is fitted in the mounting slot in the middle of the mounting pedestal, while the drawer slide is in the chute around the mounting pedestal and the drawer box;
wherein the inner lid of the main body is made up of a safety pin of the inner lid, a movable inner lid, a fixed inner lid, a gasket and a seal ring, wherein the fixed inner lid is installed inside the upper part of the inner tank by screw threads with three extraction solution holes and a safety locking hole on the top, wherein the angular spacing between extraction solution holes are 60, 120 and 180 degrees respectively, wherein the movable inner lid fits inside the fixed one with three extraction solution holes on the top; the angular spacing between adjacent mouths are 60, 20 and 180 degrees respectively, wherein there is a mounting slot in the circumferential direction and a hollow mounting boss with tapered surface, inside in the middle of the movable lid, wherein the safety pin is installed in the locking hole of the fixed inner lid and pressed against the upper surface of the gasket; the gasket is made of high-elastic: corrosion-resistant material, and the upper part is provided with three extraction solution holes corresponding to the holes on the movable inner lid wherein the three extraction solution holes are located on the upper surface of the movable inner lid and between the fixed and the movable lids, and wherein the seal ring fits in the mounting slot in the circumferential direction of the movable lid;
wherein the neutralizer storage release mechanism comprises a rubber mounting pedestal, a return spring, a rubber block, a tablet, a neutralizer release spring, a neutralizer release lid and neutralizer release push rods, wherein the rubber mount is threadconnected to the inner lower part of the boss in the middle part of the movable inner cap, and a through hole is formed in the middle part, wherein the upper part thereof is provided with a tapered surface mounting pedestal, wherein the rubber block are molded by rubber casting and fits inside the mounting boss in the middle of the movable lid with outer inward tapered side outside, inner outward and inward tapered side inside and space for neutralizer storage in the middle, wherein the mounting slot for push rod is evenly distributed in the circumferential direction under the block, wherein it is the same with four gaps which divide the lower part into four sections, wherein the outer inward tapered side contacts with the inner tapered surface in the middle of the movable inner lid, while the inner inward tapered side contacts the outer tapered surface of the rubber mounting pedestal_{:}
wherein return spring is placed between the upper surface of the rubber mounting pedestal and the lower surface of the rubber block, wherein the tablet sets between the movable inner lid and the top of the rubber block, with mounting slot and elastic seal ring in the circumferential direction, wherein the neutralizer release lid is made of an elastic material and fitted in the space where the neutralizer is stored in the middle of the rubber block, wherein on the upper part of it evenly distribute four overhang flanges which are installed on the top of the push rod mounting slot of the rubber block, inside the release lid, the neutralizer release spring is between it and the rubber block, wherein the neutralizer release push rods are fixed in the push rod mounting slot of the rubber block, wherein its upper surface and lower surface contact the tapered surface of neutralizer release lids overhang flange and the bottom of the rubber mounting pedestal's tapered surface.
